(19) United States
(12) Patent Application Publication
(10) Pub. No.: US 2017/0124313 A1
(43) Pub. Date: May 4, 2017

(54) Authentication System and Method

(71) Applicant: BIOMIDS Inc., Cotuit, MA (US)

(72) Inventors: Frank Nathaniel Mann, Cotuit, MA (US); Dennis Martins Fonseca, East Sandwich, MA (US); Kurt Baumgarten, Mendon, MA (US)

(21) Appl. No.: 15/341,305

(22) Filed: Nov. 2, 2016

Related U.S. Application Data
(60) Provisional application No. 62/249,841, filed on Nov. 2, 2015.

(51) Int. Cl. G06F 21/32; G10L 17/04; G10L 17/24; G10L 17/00

(52) U.S. Cl. CPC G06F 21/32; G10L 17/005; G10L 17/04; G10L 17/24

(57) ABSTRACT

A system and method for authenticating a person prior to granting access to a computing environment utilizing at least two biometric features of the person seeking authentication plus at least a third security feature such as a security phrase to be correctly spoken by the person. The two biometric features and the third security feature for each person are initially established during enrollment, and then compared to similar features during authentication.

### CROSS-REFERENCE TO RELATED APPLICATION

This application claims priority to U.S. Provisional Application No. 62/249,841 filed on 2 Nov. 2016. The entire contents of the above-mentioned application is incorporated herein by reference.

### FIELD OF THE INVENTION

This invention relates to authentication of individuals and more particularly to utilizing multiple parameters to confirm authentication.

### BACKGROUND OF THE INVENTION

Given all the threats that we face in our “connected” world, such as malware, viruses, worms, phishing, identity theft, and more, it is crucial to adequately protect information systems such as computers and networks and the associated data. Within the general field of Information Technology (IT), the discipline of safeguarding these systems and their data is known as Information Assurance (IA).

An important aspect of Information Assurance is authentication, which is the process by which users prove that they are who they say they are. In the classic sense, authentication includes something you know (usernames, passwords or other “credentials”), something you have (tokens), or something you are (your unique biometrics). Credentials, tokens, and biometrics each have their own advantages and disadvantages. Authentication ideally begins when a user first tries to access valuable information, resources, places, applications, or devices. In doing so, the user must prove his or her access rights and identity. For example, when logging into a computer, users commonly enter usernames and passwords. The purpose of this basic login combination is to authenticate access, but there are ways to overcome this basic security barrier.

One of the more secure techniques of authentication relies on the user's existence and biological makeup to gain access to places, systems, devices, applications, and data. These authentication methodologies use an individual's face, voice, retina, fingerprints, etc., as their password, so to speak. An iris recognition system is disclosed in U.S. Pat. No. 8,023,699 by Namgoong, for example, and one system for face recognition is described in U.S. Patent Publication No. 2014/0341430 by Ryn.

Initially, biometrics requires an individual to capture a benchmark of his or her face, voice, retina, fingerprints, etc. for comparison in the future. When secured access is being sought, the individual again captures his or her biometric feature, which is compared to the benchmark feature. If it matches, they are granted admission. One system which monitors a user's identity over time is disclosed by Kumar et al. in U.S. Pat. No. 8,926,335, for example.

It is therefore desirable to have an improved system and method for authenticating a user.

### SUMMARY OF THE INVENTION

An object of the present invention is to provide an improved system and method for authentication of a person prior to granting access to a computing environment such as a computing device, a database, and/or a software program.

Another object of the present invention is to provide effective authentication without requiring specialized equipment.

This invention features an authentication system and method that utilize at least two biometric features such as facial recognition and voice recognition, plus at least a third feature such as a security phrase, also referred herein to as a “pass phrase”. Not only does the present system determine that it is, in fact, the correct face and voice biometrics, for example, of the person seeking authentication, but also that the person has correctly provided the third feature such as speaking the pass phrase correctly.

The method includes an enrollment stage during which first and second types of biometric features of the person are obtained, and guiding the person to perform an action to serve as a third security feature. The at least two biometric features and the third security feature are stored in storage media as a stored enrollment set of security features for that person. During an authentication stage for that person, the method includes obtaining the at least two biometric features of the person and guiding the person to perform an action as the third security feature to generate an authentication set of security features for that person. The authentication set of security features is compared with the stored enrollment set of security features for that person, and access is granted to the computing environment if the authentication set matches the stored enrollment set.

In certain constructions, guiding includes instructing the person to speak a security phrase, and recording how the phrase is spoken by the person. Comparing includes matching how the security phrase is spoken during the authentication stage with how the security phrase was spoken during the enrollment stage.

In some embodiments, one or more of the biometric features is converted to at least one hash value.

### BRIEF DESCRIPTION OF THE DRAWINGS

In what follows, preferred embodiments of the invention are explained in more detail with reference to the drawings, in which:

FIG. 1 is a schematic diagram of an authentication system according to the present invention at stages of enrollment, authentication and access determination;

FIGS. 2A and 2B are sequence diagrams of enrollment and authentication plus access determination, respectively;

FIG. 3 is a schematic block diagram of components of an authentication system according to the present invention;

FIGS. 4A-4C are flowcharts illustrating process steps in the authentication system of FIG. 3;

FIG. 5A is a flowchart illustrating another process of authentication according to the present invention utilizing hash values; and

FIG. 5B is a flowchart illustrating an emergency access process of authentication according to the present invention.

### DETAILED DESCRIPTION OF THE PRESENTLY PREFERRED EMBODIMENTS

An authentication system and method according to the present invention may be achieved by combining at least two biometric features such as facial recognition and voice recognition together and then by adding another layer of security such as two or more words to serve as a spoken security phrase, also referred to herein as a “pass phrase”. Not only does the present system determine that it is, in fact, the correct face and voice, but also that the user has spoken the pass phrase correctly.

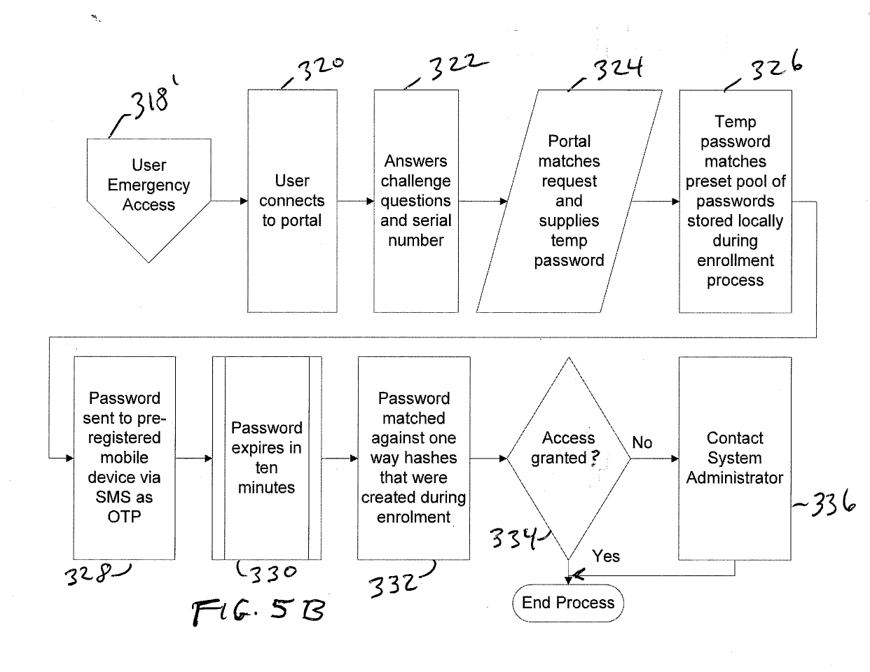

In some constructions, the system creates one or more substantially stronger biometric passwords through the use of biometric markers defined as a multiple character string of encrypted values based upon those markers being assigned. The biometric markers are randomized based upon a selected formula and are encrypted using industry standard strong encryption available at the time. The values generated by the initial enrollment of a user's biometric markers are hashed (one way) and stored in the access control mechanism as a password. The term “hashed” includes the use of hash functions, such as one or more cryptographic hash functions, to create hash values representing one or more biometric features. Once a user proceeds to log in biometrically after first enrollment, the same biometric markers and selected formula are used to generate another one-way hash that is compared to the hash on file in the access control mechanism. If the hashes match, then access is granted. One example of this construction is illustrated in FIGS. 5A-5B and discussed in more detail below.

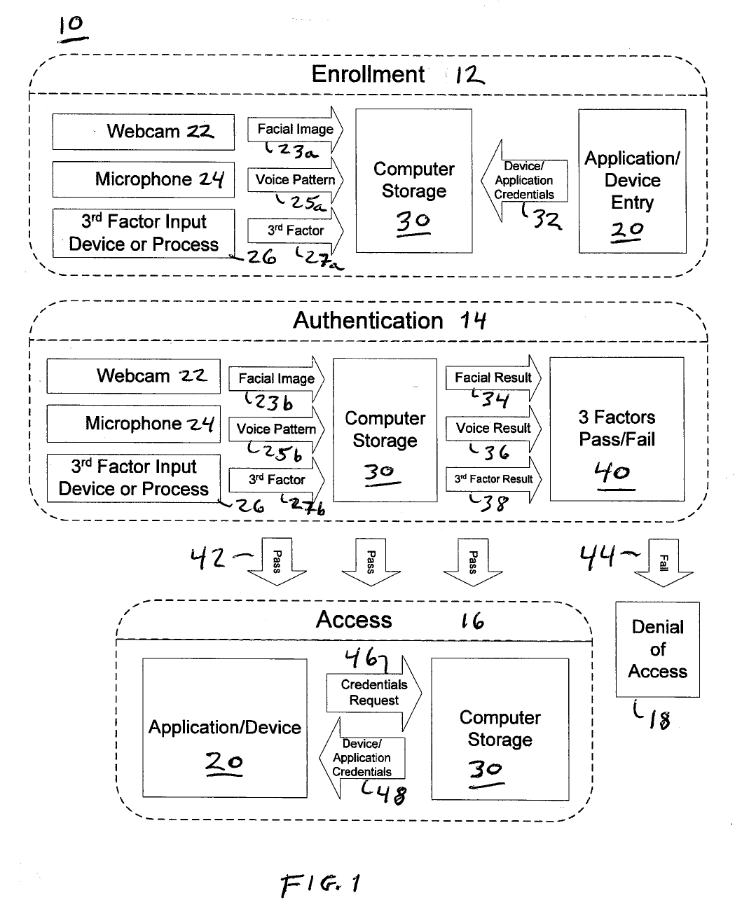

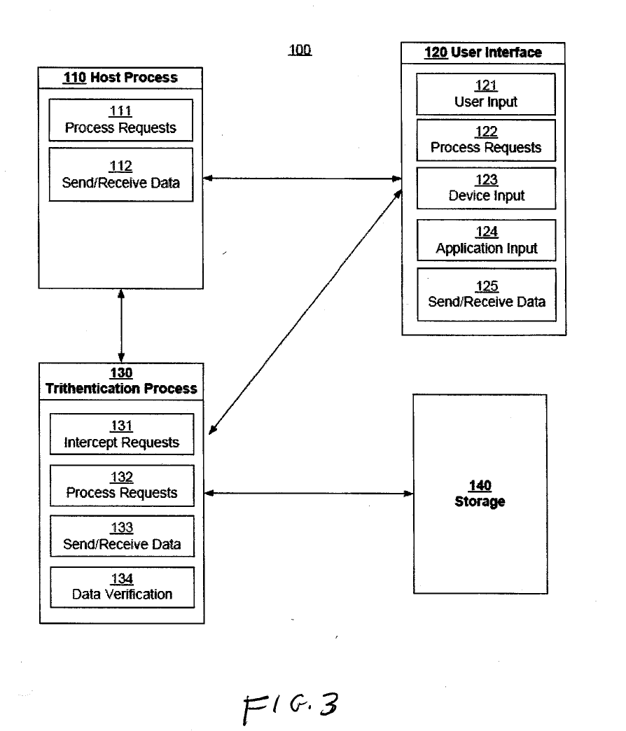

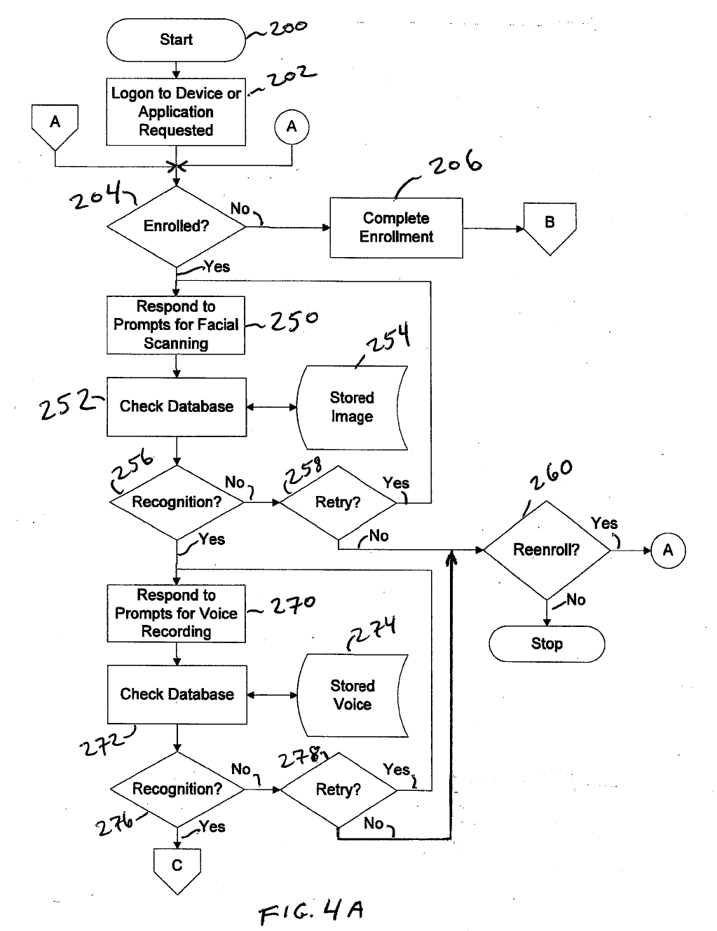

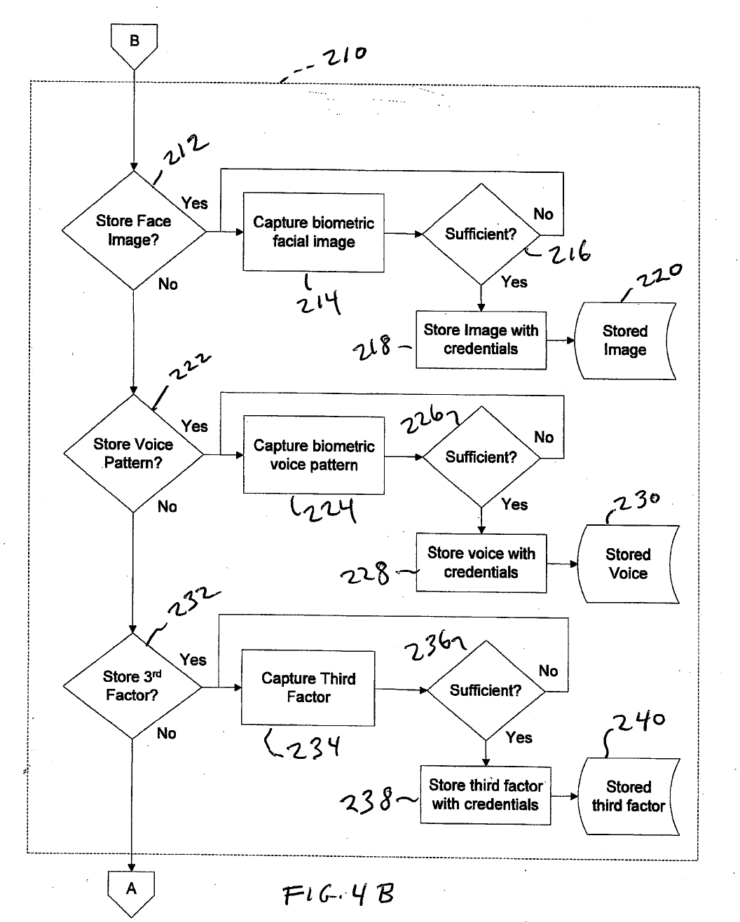

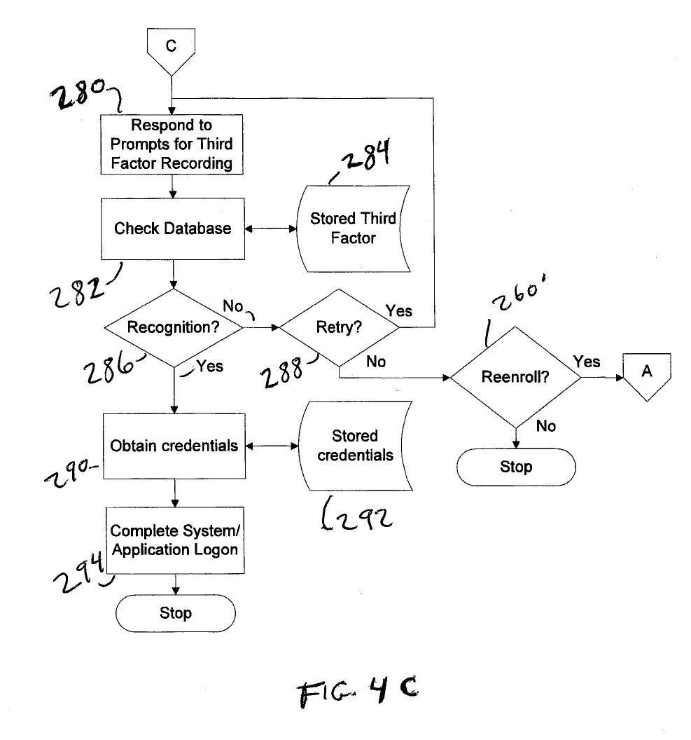

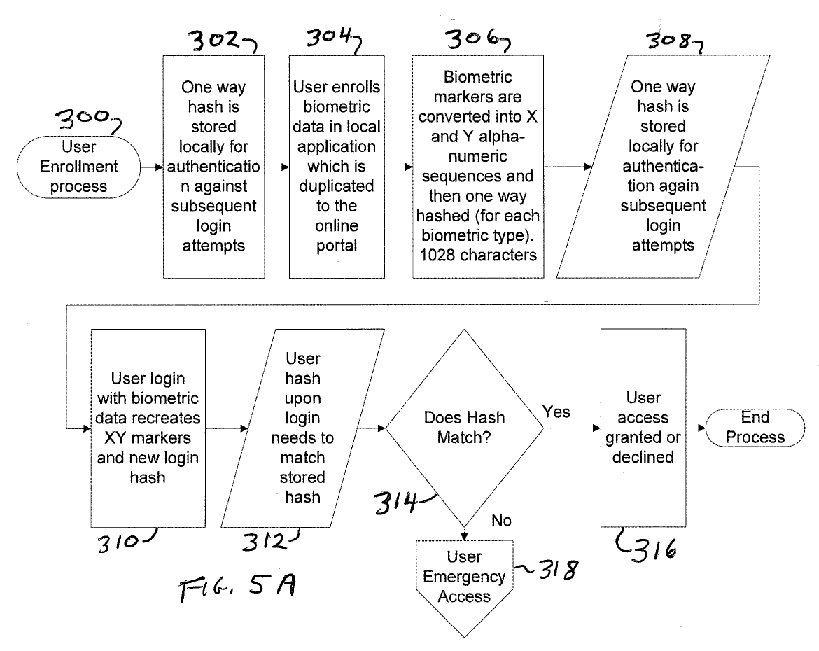

System 10, FIG. 1, has an enrollment stage 12, an authentication stage 14, and an access action stage 16 or a denial of access stage 18 to grant or deny, respectively, access to a computing environment represented by Application/Device 20. In this construction, enrollment 12 and authentication 14 each utilize a webcam 22 which provides a facial image 23a, 23b to a computer storage 30, a microphone 24 which provides a voice pattern 25a, 25b, and a selected third factor input device or process 26 which provides a third security factor 27a, 27b to computer storage 30 during the respective stages. In preferred constructions, standard equipment of a computing device is utilized, such as a standard webcam and a standard microphone. During the initial enrollment step 12, the Application/Device 20 provides Device/Application Credentials 32 to computer storage media 30 as described in more detail below in relation to FIGS. 3-4C.

During authentication stage 14, a person seeking access to Application/Device 20 provides an authentication facial image 23b, a voice pattern 25b, and a third factor 27b, which are compared by a processor to enrollment facial image 23a, voice pattern 25a and third factor 27a as stored in computer storage 30. A facial result 34, a voice result 36 and a third factor result 38 are analyzed by the processor as Three Factors Pass/Fail 40. Three passes are represented by arrows 42 which lead to Access 16 with Credentials Request 46 and Device/Application Credentials 48 being shared between Application/Device 20 and computer storage 30. A fail result 44 generates denial of access 18.

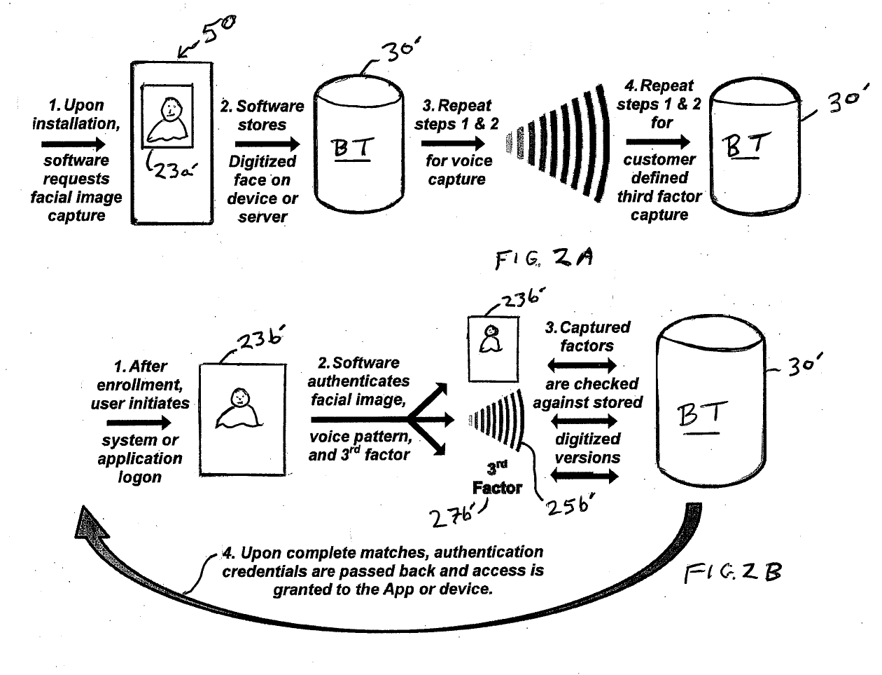

The operation of system 10 is further explained by sequence diagrams in FIGS. 2A and 2B for Enrollment and Authentication stages, respectively. During Step 1 of enrollment, FIG. 2A, after software implementing the present authentication invention is loaded on computing device 50 such as a smart phone, a laptop or a personal computer, a person (also referred to herein as a “user”) is instructed by the installed system software to capture a facial image 23a′ on the computing device 50. The digitized facial image is stored, Step 2, in computer storage 30 within device 50 as part of a biometric template BT for that person. Steps 1 & 2 are repeated as Step 3 for a second biometric feature such as voice capture, and then steps 1 & 2 are repeated as a Step 4 for a “customer defined third factor capture”. In some constructions the third factor is specified by the Application/Device to be accessed and, in other constructions, the third factor is selected by the person from a menu of possible choices to serve as the third factor.

During Step 1 of Authentication, FIG. 2B, the user initiates the authentication system and is instructed to provide facial image 23b′. System software authenticates the facial image, Step 2, which is repeated to obtain voice pattern 25b′ and third security factor 27b′. The captured factors are compared in Step 3 to the stored digitized versions. When a complete match for each specified security factor is achieved, Step 4, authentication credentials are passed back to the computing device and access is granted to the desired Application or device.

Trithentication™ system 100, FIG. 3, implements a highly secure authentication process that replaces password entry into devices and applications. It is achieved by combining biometric facial recognition and voice recognition together and then by adding a third factor of security (such as a “pass phrase”). In order to access a specific device or application, the software must affirm the presence of the preregistered individual's face and voice, and also meet the criteria for the third factor.

In this construction, system 100 includes a host process 110 with process requests 111 and Send/Receive Data 112, and a Trithentication™ process 130 with Intercept Requests 131, Process Requests 132, Send/Receive Data 133 and Data Verification 134. System 100 further includes storage media 140 and a User Interface 120 having User Input 121, Process Requests 122, Device Input 123, Application Input 124 and Send/Receive Data 125.

Deploying the Trithentication™ system 100 preferably tightly integrates a Trithentication™ process 130 with the host process 110 utilizing existing software products or computerized devices essentially allowing it to control the submission of credentials to either “in the background”, that is, seamlessly without requiring guidance from a user. Although it could provide a convenient replacement to the entry of difficult-to-remember User IDs and passwords, the entry of credentials would remain as a failsafe process to provide the necessary access should a physical condition prohibit the use of the person's biometric.

In one construction, FIGS. 4A-4C, steps in the Trithentication™ system deployment include (with reference numerals in parentheses referring to the components of system 100 in FIG. 3):
1. (110) The host application or device is accessed, step 200.
2. (131) Trithentication™ software intercepts the request to access the application or device, step 202.
3. (132) The Trithentication™ software processes the request and checks storage (140) to see if the user has previously registered the three templates of his or her biometrics, step 204.
4. If he or she has not registered (134), step 206, registration (which is also referred to as “enrollment”) proceeds as follows as illustrated in FIG. 4B within dashed lines 210:
   (132) A request for registration/enrollment is initiated back to the User Interface.
   (122) The user begins the process of enrollment.
   (121) The software requests that the user capture basic information in addition to his or her facial image, step 212.
   The captured facial image is processed (122) and (125), steps 214 and 216, and presented to the Trithentication™ “engine” along with the user's basic information.
   The engine processes the request (132) and attempts to verify it as a valid image (134).
   Once the image is verified, it is then prepared (132) and moved into storage (140) along with the user's basic information, steps 218 and 220.
   (140) The storage of the image is verified (134) and control is passed back (132) allowing the user to continue.
   (121) The software requests that the user then capture a biometric voice pattern to identify him or herself, step 222.
   That captured voice pattern is processed (122) and (125), steps 224 and 226, and presented to the Trithentication™ “engine” (132). At this point, it is verified as a valid human voice (134).
   Once the voice pattern is validated, it is prepared (132) and moved into storage (140) and associated with the user's basic information.
   (140) Storage of the voice pattern is verified (134), steps 228 and 230, and control is passed back (132) to continue input capture.
   (121) The software then directs the user to capture a third factor to identify him or herself, step 232.
   That captured third factor is processed (122) and (125), steps 234 and 236, and presented to the Trithentication™ “engine” (132). At this point, it is verified as a valid third factor (134).
   Once the third factor is validated, it is prepared (132) and moved into storage (140), steps 238 and 240, and associated with the user's basic information.
   (140) Storage of the third factor is verified (134) and control is passed back (132) to continue the process.
   (111) At this point, control is returned to the host process, step 202 or 204, FIG. 4A.
   (111) The host process (application or device) processes a request for the entry of a User ID and password.
   (131) Trithentication™ software intercepts request and passes control to the user interface (122).
   (122) The user interface processes the request and obtains (121) the User ID and password.
   (122) That captured credentials are processed and (125) presented to the Trithentication™ “engine” (132).
   (133) The Trithentication™ software stores the credentials (140) associating them with the three Trithentication™ factors and basic information already stored.
   (140) Storage of the credentials is verified (134) and control is passed back (132) to the host to continue the process (111).

(100) Trithentication™ enrollment is completed.

Steps in the use of Trithentication™ Technique include:
1. (110) The host application or device is accessed, steps 200 and 202.
2. (131) The Trithentication™ software intercepts the request to access the application or device, step 204.
3. (132) The Trithentication™ software passes control to the user interface, which requests (122) that the user capture basic information (121) in addition to his or her facial image, step 250.
4. The captured facial image is processed (122), steps 252 and 254, and sent to the Trithentication™ “engine” along with the user's basic information (125).
5. The engine receives the image (133), processes the request (132), and attempts to verify it as a valid image (134) (133) compared to the stored image (140), step 254.
6. Once the image is verified (134), steps 256 and 258, including a possible reenrollment subroutine 260 if selected, then control is passed back (132) to the user interface (122) allowing the user to continue.
7. (121) The user then captures a biometric voice pattern to identify him or herself, step 270.
8. That captured voice pattern is processed (122) and (125), steps 272, and presented to the Trithentication™ “engine” (132).
9. The engine receives the voice pattern (133), processes the request (132), and attempts to verify it as a valid voice pattern (134) (133) compared to the stored pattern (140), step 274, with a retry step 278 if needed.
10. Once the voice pattern is verified (134), step 276, then control is passed back (132) allowing the user to continue.
11. (122) The software then directs the user to (121) capture a third factor to identify him or herself, step 280, FIG. 4C.
12. That captured third factor is processed (122) and (125), step 282, and presented to the Trithentication™ “engine” (132).
13. The engine receives the third factor (133), processes the request (132), and attempts to verify it as a valid third factor (134) (133) compared to the stored version (140), step 284.
14. Once the third factor is validated in step 286, with possible retry step 288 and reenroll step 260′ if desired, the request is processed (132), step 290, and the credentials are retrieved (133) from storage (140), step 292.
15. Once the credentials are received, the authentication request is processed (132) and the credentials are supplied (133) to the host application or device (112), step 294.

(111) The credentials are processed by the host and access is gained.

In addition to the biometric basis of Trithentication™, additional authentication factors that could be considered for high levels of security within the Trithentication™ framework include:
Credentials entered manually or via speech recognition
Tokens
Photo IDs such as—licenses, passports, ID cards, or employee badges with photos or barcodes
Challenge question services from firms like Acxiom

Operation of another authentication system according to the present invention is illustrated in FIGS. 5A-5B. In this construction, the system creates one or more substantially stronger biometric passwords through the use of biometric markers defined as a multiple character string of encrypted values based upon those markers being assigned such alphanumeric values along an “X” and “Y” axis. The biometric markers are randomized based upon a selected formula and are encrypted using industry standard strong encryption available at the time. The values generated by the initial enrollment of a user's biometric markers are hashed (one way) and stored in the access control mechanism as a password.

The user enrollment process begins, step 300, FIG. 5A, and a one-way hash value is created and stored locally, step 302, for authentication against subsequent login attempts. The user enrols biometric data, step 304, in a local application which is duplicated to an on-line portal in one construction. Biometric markers are converted, step 306, into X and Y alpha-numeric sequences, such as 1028 characters, and then one-way hashed for each biometric feature, also referred to as a biometric type. The one-way hash for each biometric type is stored locally, step 308, for authentication against subsequent login attempts.

Once a user proceeds to log in biometrically after first enrollment, the system recreates XY markers and new login hashes for the same biometric markers and selected formula to generate another one-way hash per biometric marker that is compared to the hash on file in the access control mechanism. A one-way hash is retrieved for authentication, step 310, against subsequent login attempts. The user hash upon login needs to match the stored hash, step 312. If the hashes match, step 314, then access is granted, step 316. As a method to defeat mistakes in rejecting legitimate logins due to small differences in lighting, background noise, etc., in one construction a small margin of error is incorporated in the mechanism for biometric marker values to account for slight differences in these environmental variants.

In the case where the system failed and the user could not login, a backup “backdoor” login could be obtained by using an online portal where the user was pre-registered with the serial number of their installation as well as a password to access the portal coupled with challenge questions. Once the user is able to login and request an emergency password for access, steps 318 and 318′, FIG. 5B, the user connects to a portal, step 320, and answers challenge questions, step 322, and may be required to provide further information such as a serial number. The portal matches the request, step 324, and supplies a temporary password if the match is successful. The portal also determines, step 326, that the temporary password matches a preset pool of passwords stored locally during the enrollment process.

In one construction, the system will send, step 328, a one-time password with a short time period, such as a ten minute activation time, step 330, to a pre-registered mobile phone number in the form of an SMS text. The mobile phone with one time password serves as a soft token and thus second factor of authentication if the biometric access control fails to function. The one-time password expires after ten minutes and can never be re-used. The value of that backup password is based upon the serial number of the installation using a second formula and encryption standard to obfuscate the underlying values stored in both the user system and the portal system that SMS texts the decrypted password in clear text to the end user. The password is matched against one-way hashes that were created during enrollment, step 332, and access is granted, step 334, if the match is successful. If access is denied, then a system administrator is contacted, step 336.

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is the intention, therefore, to be limited only as indicated by the scope of the claims appended hereto. Other embodiments will occur to those skilled in the art and are within the following claims.

What is claimed is:

1. A method for authenticating a person prior to granting access to a computing environment, comprising:
during an enrollment stage, obtaining a first type of biometric feature of the person, obtaining at least a second type of biometric feature of the person, and guiding the person to perform an action to serve as a third security feature;
storing in storage media the at least two biometric features and the third security feature as a stored enrollment set of security features for that person;
during an authentication stage for that person, obtaining the at least two biometric features of the person and guiding the person to perform an action as the third security feature to generate an authentication set of security features for that person;
comparing the authentication set of security features with the stored enrollment set of security features for that person; and
granting access to the computing environment if the authentication set matches the stored enrollment set.

2. The method of claim 1 wherein guiding includes instructing the person to speak a security phrase, and recording how the phrase is spoken by the person.

3. The method of claim 2 wherein comparing includes matching how the security phrase is spoken during the authentication stage with how the security phrase was spoken during the enrollment stage.

4. The method of claim 1 wherein at least one of the biometric features is converted to at least one hash value.
